(19) United States
(12) Patent Application Publication
(10) Pub. No.: US 2007/0026306 A1
(43) Pub. Date: Feb. 1, 2007

(54) Battery module

(76) Inventors: Gun-Goo Lee, Suwon-si (KR); Tae-Yong Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/495,209

(22) Filed: Jul. 28, 2006

(30) Foreign Application Priority Data
Jul. 29, 2005 (KR) 10-2005-0069510

(51) Int. Cl. H01M 2/20

(52) U.S. Cl. 429/160; 429/178

(57) ABSTRACT

A battery module includes a plurality of unit batteries each having an electrode terminal and a connecting member for interconnecting the electrode terminals of the unit batteries. The connecting member includes a pair of coupling devices elastically coupled to the electrode terminal. The coupling devices are connected to each other by an electric cable.

### CROSS-REFERENCE TO RELATED APPLICATION

This application claims priority to Korean patent application No. 10-2005-0069510 filed in the Korean Intellectual Property Office on Jul. 29, 2005, and all the benefits accruing therefrom under 35 U.S.C. §119. The contents of the Korean patent application are incorporated herein by reference in their entirety.

### BACKGROUND OF THE INVENTION

1. Field of the Invention

The present invention relates to a battery module comprising a plurality of unit batteries. More particularly, the invention pertains to battery modules with a coupling device to interconnect the unit batteries.

2. Description of the Related Art

Unlike a primary battery, a rechargeable battery may be recharged. Low power batteries are used for various portable electronic devices such as phones, laptop computers, and camcorders. High power batteries are used as a power source for driving motors, such as those in hybrid electric vehicles.

Depending on their external shape, secondary batteries may be classified into different types, for example, prismatic and cylindrical batteries. When they are used to drive motors of machines requiring a high power source such as hybrid electric vehicles, the secondary batteries may be formed into a high power rechargeable battery module.

A rechargeable battery module is formed by serially connecting several secondary batteries (hereinafter “unit battery”). Each of the unit batteries includes an electrode assembly in which a separator is interposed between a positive electrode and a negative electrode. The electrode assembly is inserted inside a container, and a cap assembly is assembled with the container to seal the container. The cap assembly may include terminals extending from the interior to the exterior of the container and the terminals may be electrically connected to the positive electrode and the negative electrode.

If the unit batteries are prismatic type batteries, the unit batteries are arranged such that positive and negative terminals of one unit battery alternate with the positive and negative terminals of an adjacent unit battery. Electric conductor adaptors are typically mounted on the negative and positive terminals such that they are electrically connected to form the battery module. The negative and positive terminals are partly threaded so that the electric conductor adaptors are fixed by nuts.

In the manufacturing the battery modules, it is time-consuming to individually connect the electric conductor adaptors to the terminals. T the process for electrically connecting the unit batteries may be labor intensive work.

In addition, the electric conductor adaptors are provided with respective holes through which the positive and negative terminals. Therefore, the electric conductor adaptors can be combined with the terminals each having a predetermined diameter corresponding to that of the hole formed on the electric conductor adaptor. If the diameter of the terminal is smaller than that of the hole, they may not form a proper electric connection. When the diameter of the terminal is greater than that of the hole, the electric conductor adaptors may not be fitting into the holes.

Furthermore, the physical coupling between the electric conductor adaptors and the terminals is very firm. Therefore, when the unit batteries of the battery module is deformed due to, for example, swelling, deformation energy may be directly applied to the coupling portions, and thus the coupling portions may be damaged.

### SUMMARY OF CERTAIN INVENTIVE ASPECTS

One aspect of the invention provides a battery module. The battery module comprises: a plurality of unit batteries, each comprising an electrode terminal; and

a connecting member for interconnecting at least two electrode terminals, wherein the connecting member comprises a coupling device configured to receive and elastically grip the electrode terminal.

In the foregoing battery module, the connecting member may further comprise another coupling device, wherein the coupling devices are electrically connected to each other by a conductive line. The coupling device may comprise a device to receive the electrode terminal and an elastic member biasing the device toward the electrode terminal so that the device firmly grips the electrode terminal. The device may comprise an elastically movable piece with a surface to contact the electrode terminal, and wherein the surface may be complementary to an exterior contour of the electrode terminal. The elastically movable piece may be formed of a metal. The surface may comprise a curved portion. The may comprise a threaded portion. The coupling device may further comprise a housing enclosing the device. The elastic member may comprise a spring. The elastic member may be selected from the group consisting of a tension spring, a compression spring and an elastic band.

Still in the foregoing battery module, the coupling device may comprise an elastically movable piece configured to adapt the coupling device to receive and grip differently sized electrode terminals. The coupling device may comprise a movable device and an elastic member connected to the movable piece, and wherein the elastic member may be to cause the movable piece to elastically move so as to contact the electrode terminal. The movable piece may be configured to substantially sheathe the electrode terminal. The movable piece may be substantially cylindrically configured with a hollow so as to receive and seize the electrode terminal within the hollow. The cylindrically configured movable piece may be made of a single curled sheet with two edges, which are connected by the elastic member. The coupling device may comprise two or more curved pieces connected to each other via two or more elastic members so as to form a cylindrical configuration with a hollow to receive the electrode terminal therein.

Still in the foregoing battery module, the coupling device may further comprise a case housing the movable piece and the elastic member; the movable piece is arranged to form a space to receive the electrode terminal therein with or without one or more movable pieces; and the elastic member may be located between the movable piece and the case and may be configured to cause the movable piece to elastically move within the case. The coupling device may further comprise a guide member configured to guide receiving of the electrode terminal. The coupling device may further comprise a housing to house the movable piece and the elastic member, and the guide member connects one end of the housing to one end of the movable member. The guide member may be formed of an elastic material. The guide member may be formed in a band shape.

One aspect of the present invention provides a battery module having electric conductor adaptors that can be elastically coupled to electrode terminals in response to sizes of the electrode terminals.

In embodiments, electric conductor adaptors can be easily installed on or removed from electrode terminals.

In embodiments, damage of coupling portions by deforming energy of the unit batteries can be effectively prevented.

According to an embodiment of the present invention, there is provided a battery module including: a plurality of unit batteries each having an electrode terminal; and a connecting member for interconnecting the electrode terminals of the unit batteries. The connecting member comprises a coupling device elastically coupled to the electrode terminal.

The connecting member may further include another coupling device and the coupling devices are electrically connected to each other by a conductive member. The coupling device may include a terminal receiver and an elastic member biasing the terminal receiver toward the electrode terminal so that the terminal receiver contacts closely the electrode terminal. The terminal receiver may include a movable piece that formed in a shape corresponding to a contour of the electrode terminal.

The movable piece may be formed of a metal plate and have a curved surface portion corresponding to the contour of the electrode terminal and flat surface portions formed on opposite side ends of the curved surface portion. The movable piece may be provided at an inner surface with a screw thread.

The connecting member may further include a housing enclosing the coupling device.

The elastic member may be selected from the group consisting of a tensioned spring, a compression spring and an elastic band.

The elastic member may be fixedly disposed between the flat surface portions. Alternatively, the elastic member may be fixedly disposed between the housing and the coupling device.

The connecting member may further include a guide member disposed on the coupling device to guide the insertion of the electrode terminal into the coupling device. The guide member connects one end of the housing to one end of the coupling device. The guide member may be formed of an elastic material. The guide member may be formed in a band shape.

The conductive member may be an electric cable.

### BRIEF DESCRIPTION OF THE DRAWINGS

FIG. 1 is a perspective view of a battery module according to an exemplary embodiment of the present invention.

FIG. 2 is a sectional view taken along line II-Ii of FIG. 1.

FIG. 3 is a perspective view of a coupling device to receive and grip a connection member of the rechargeable battery module of FIG. 1.

FIG. 4 is a perspective view of a modified example of the coupling device.

FIG. 5 is a sectional view of another modified example of the coupling device.

FIG. 6 is a sectional view of still another modified example of the coupling device.

FIG. 7 is a perspective view of still yet another modified example of the coupling device.

FIG. 8 is a sectional view taken along line VIII-VIII of FIG. 7.

FIG. 9 is a perspective view of still yet another modified example of the coupling device

### DETAILED DESCRIPTION OF CERTAIN INVENTIVE EMBODIMENTS

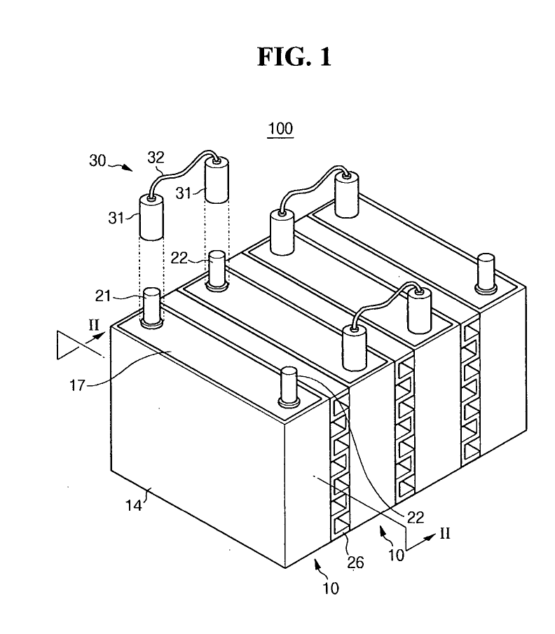

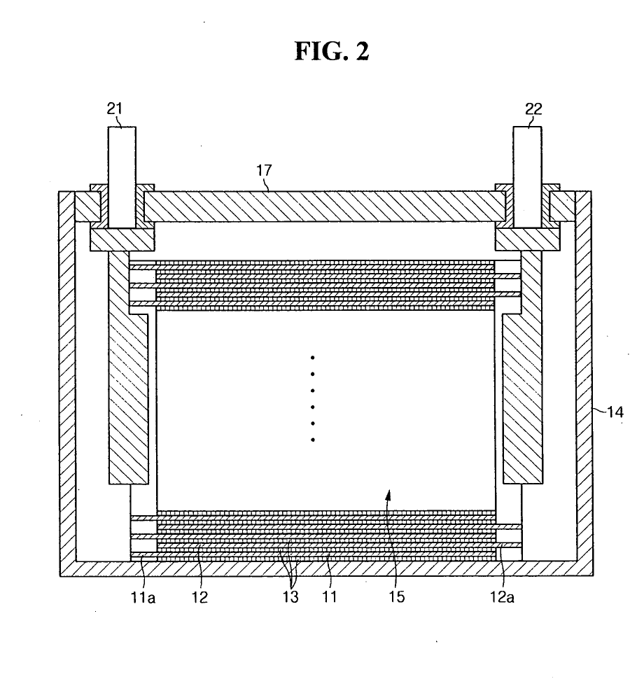

With reference to FIGS. 1 and 2, a battery module includes a plurality of unit batteries 10. Each of the unit batteries 10 includes an electrode assembly 15, a case 14 for receiving the electrode assembly, a cap plate 17 coupled to the case 14 to seal the case 14, and positive and negative terminals 21 and 22. The electrode assembly 15 includes a positive electrode 11, a negative electrode 12 and a separator 13, which is interposed between the positive and negative electrodes 11 and 12. The positive and negative terminals 21 and 22 are electrically coupled to the positive and negative electrodes 11 and 12 and protrude out of the cap plate 17.

The case 14 may be formed of a conductive material such as aluminum, an aluminum alloy, or steel plated with nickel. The case 14 may be prismatic, which has an internal space for receiving the electrode assembly 15.

Although the unit battery 10 is prismatic in this embodiment, the present invention is not limited thereto.

The positive and negative terminals 21 and 22 are oriented generally in the same direction, although the invention is not limited thereto. The unit batteries are arranged such that positive and negative terminals of one unit battery alternate with the positive and negative terminals of an adjacent unit battery. That is, That is, the positive terminal 21 of one unit battery 10 is adjacent to the negative terminal 22 of the adjacent unit battery 10.

In certain embodiments, a barrier 26 defining a coolant flowing channel may be installed between the unit batteries 10 to dissipate heat generated from the unit batteries 10.

As described above, along each of the both sides of the battery module, the positive and negative terminals 21 and 22 are alternately arranged at predetermined intervals. This terminal arrangement can be regarded as a line along which the positive and negative terminals 21 and 22 are arranged.

In the above-described battery module, the unit batteries 10 are electrically connected in series. To achieve this, the positive terminal 21 of one unit battery 10 is connected to the negative terminal of the adjacent or another unit battery 10 by a connecting member 30. In this embodiment, the connecting member 30 includes a pair of coupling devices 31 coupled to the respective positive and negative terminals 21 and 22 and a conductive member 32 interconnecting the pair of coupling devices 31.

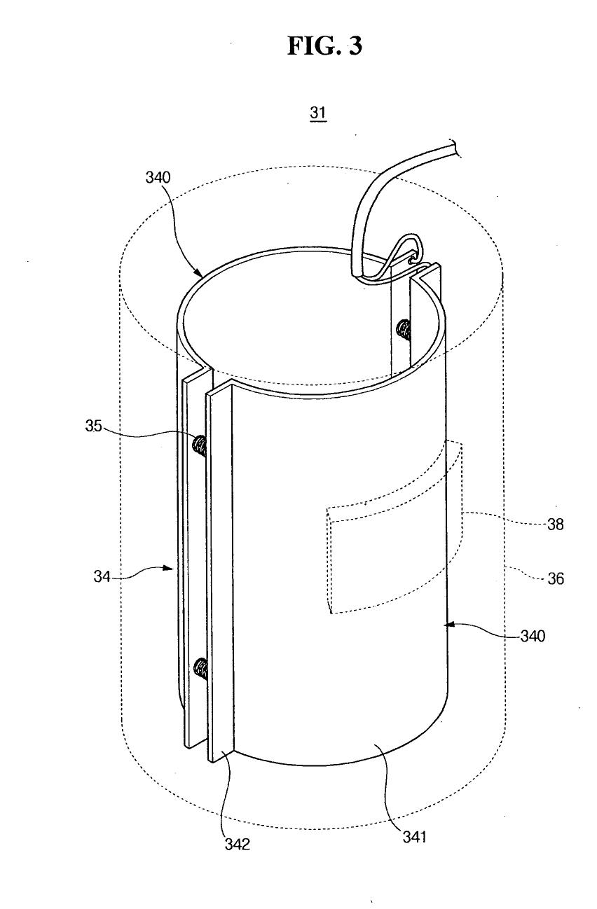

As shown in FIG. 3, the coupling device 31 includes a housing 36, a terminal receiver 34 fitted closely around the positive or negative terminal 21 or 22, and elastic members 35 for providing elastic force to the terminal receiver 34.

The terminal receiver 34 includes a pair of movable pieces 340, which includes a surface corresponding or complementary to the external surface or contour of the terminals 21 or 22.

The elastic members 35 are connected and disposed between the movable pieces 340 so that the movable pieces 340 can elastically move. That is, the elastic members 350 are disposed at edges of the movable pieces 340 and interconnect the movable pieces 340. The number and location of the movable pieces 340 are not limited to a specific case.

The movable piece 340 is cylindrical or semi-cylindrical, which has a curved surface portion 341 contacting closely the positive or negative terminal 21 or 22 and a flat surface portion 342 formed on both side ends of the curved surface portion 341.

The elastic member 35 is formed of a tension spring installed between the flat surface portions 342 of the movable pieces 340. Therefore, when the positive or negative terminal 21 or 22 is inserted into the space defined between the movable pieces 340, the elastic members 35 bias the movable pieces 340 toward the positive or negative terminal 21 or 22 so that the movable pieces 340 can contact closely the positive or negative terminal 21 or 22.

The conductive member 32 is installed on the movable pieces 340. The conductive member 32 may be formed of an electrically conductive wire that can be coupled to the movable pieces 340 by soldering.

Meanwhile, the housing 36 is formed with an inner space to accommodate the displacement of the movable pieces 340 within the space, particularly when the positive or negative terminal 21 or 22 is inserted into the space. The housing 36 may be formed of a highly insulating material. The movable pieces 340 are formed of a conductive material for the electric connection between the positive and negative terminals 21 and 22.

Furthermore, in some embodiments, elastic bodies such as sponges may be interposed between the housing 36 and the movable pieces 340 of the terminal receiver 34 so that the movable pieces 340 of the terminal receiver 34 can be stably disposed in the housing 36.

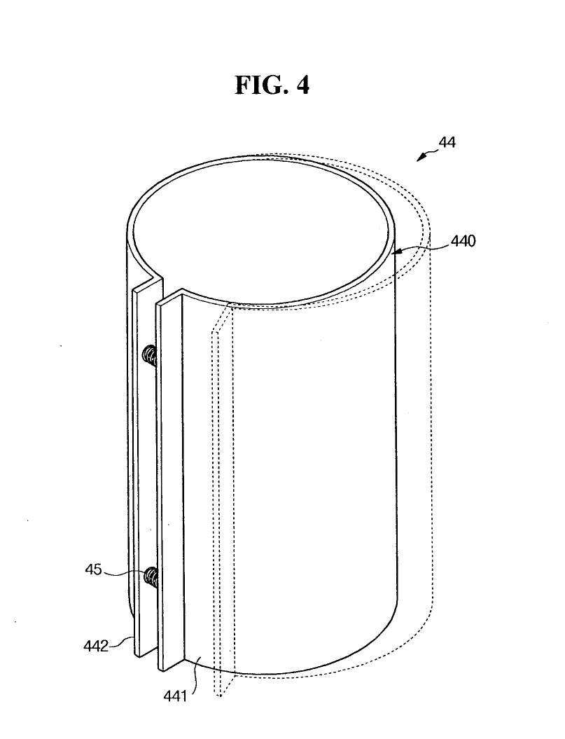

FIG. 4 shows a modified example of the coupling device. The coupling device of this modified example is identical to that of the foregoing example except for the terminal receiver. Therefore, only the terminal receiver will be described hereinafter.

Referring to FIG. 4, a terminal receiver 44 of this modified example is formed in a single plate body corresponding to the positive or negative terminal.

That is, the terminal receiver 44 is cylindrical, having a curved surface portion 441 and flat surface portions 442 formed on opposite ends of the curved surface portion 441. Elastic members 45 are interposed between the flat surface portions 442.

When the terminal is inserted into the movable piece 440 of the terminal receiver 44, the movable piece 440 of the terminal receiver 44 is elastically deformed in response to the shape of the terminal. At this point, the elastic members 45 disposed between the flat surface portions 442 bias the movable piece 440 toward the terminal so that the movable piece 44 contacts closely the terminal inserted therein.

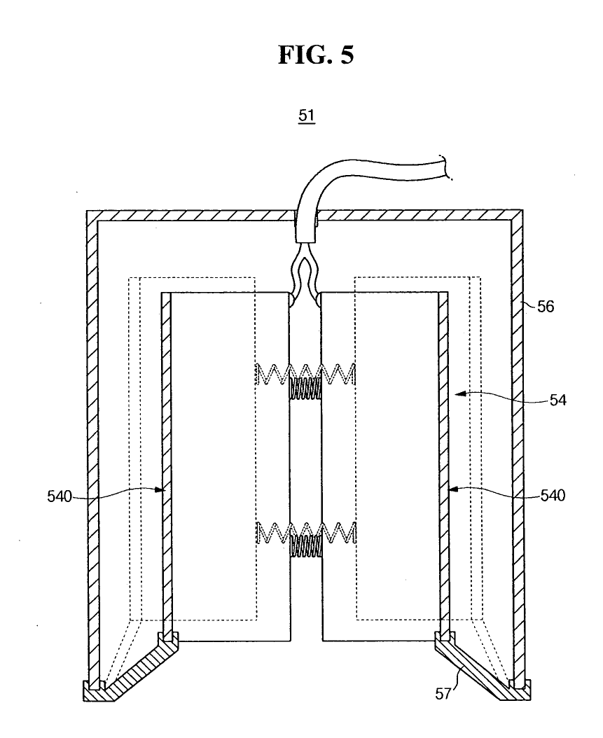

Referring to FIG. 5, a guide member 57 may be added to the coupling device of FIG. 3. The guide member 57 extends from a lower end of a terminal receiver 54 to a lower end of a housing 56. That is, the guide member 57 connects the lower end of the terminal receiver 54 to the lower end of the housing 56.

The guide member 57 may be formed of rubber so that it can be elastically deformed. One end of the guide member 57 is coupled to the lower end of the movable pieces 540 and the other end of the guide member 57 is coupled to the lower end of the housing 36.

In this modified example, the guide member 57 is formed in a band shape disposed along a circumference of the movable pieces 540 and the housing 56. However, the present invention is not limited to this case. For example, the guide member 57 may be formed of bands the number of which is the same as that of the movable pieces 540.

When the terminal is inserted in the space defined by the movable pieces 540, the guide member 57 is elastically deformed to guide the terminal into the space defined between the movable pieces 540.

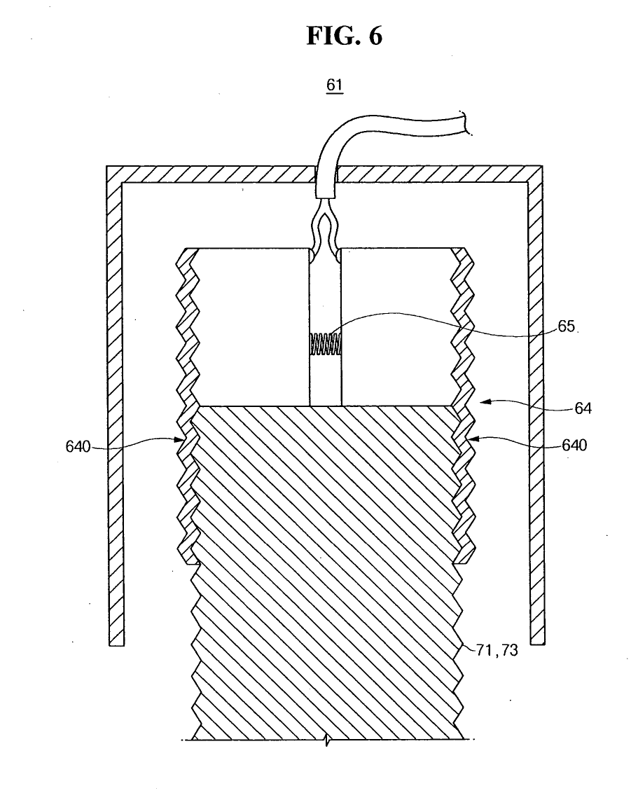

FIG. 6 shows another modified example of the coupling device. The coupling device of this modified example is identical to that of FIG. 3 except for the movable piece. Therefore, only the movable piece will be described hereinafter.

A movable piece 640 of the present modified example is provided at an inner surface with threads. In this case, a positive or negative terminal 71 or 73 is also provided at an outer surface with threads so that the positive or negative terminal 71 or 73 can be thread-coupled to the movable piece 640, thereby more securely coupling the positive or negative terminal 71 or 73 to the movable piece 640.

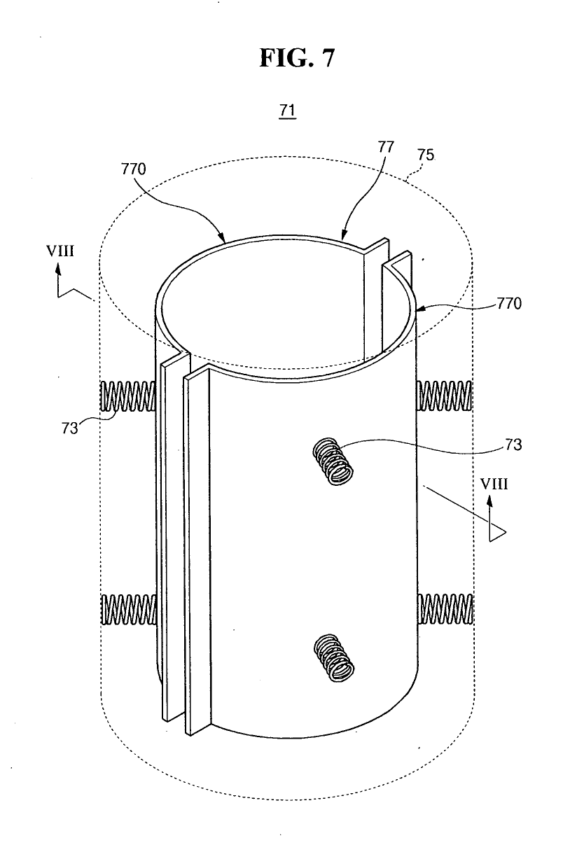

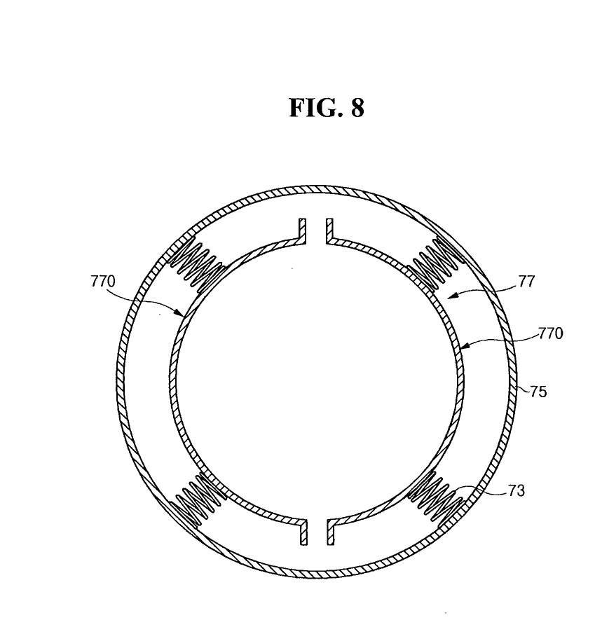

FIGS. 7 and 8 show another modified example of the coupling device. The coupling device of this modified example is identical to that of FIG. 3 except for the elastic members. Therefore, only the elastic members will be described hereinafter.

As shown in FIGS. 7 and 8, elastic members 73 of the present modified example are formed of compression springs. The elastic members 73 are disposed between a housing 75 and movable pieces 770 of a terminal receiver 77.

That is, the elastic members 73 are disposed between an inner circumference of the housing 75 and outer circumferences of the movable piece 770. When a terminal is inserted into the space defined between the movable pieces 770, the elastic members 73 are compressed while biasing the movable pieces 770 toward the terminal. The number and disposition of the movable pieces are not limited to a specific case depicted in FIGS. 7 and 8.

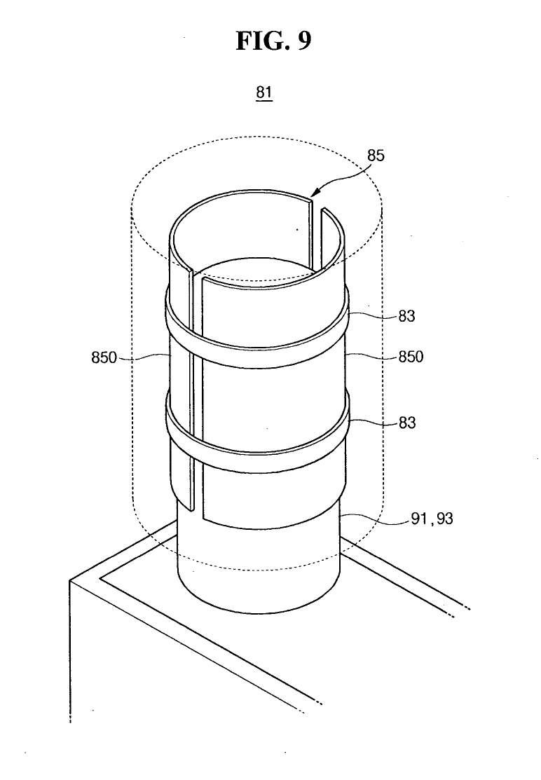

FIG. 9 shows another modified example of the coupling device. The coupling device of this modified example is identical to that of FIG. 3 except for the elastic members. Therefore, only the elastic members will be described hereinafter.

As shown in FIG. 9, elastic members of this modified example are formed of elastic bands installed around movable pieces 850 of a terminal receiver 85.

In this modified example, the movable pieces 850 are surrounded by elastic bands 83.

When a positive or negative terminal 91 or 93 are inserted into the space defined between the movable pieces 850 of the terminal receiver 85, the elastic bands 83 are elastically deformed so that the movable pieces 850 can contact and grip the terminal entering into the space.

The battery modules according to embodiments of the present invention may be used as the power source for motor driving devices, such as the hybrid electric vehicles, electric vehicles, wireless vacuum cleaners, motorbikes, or motor scooters.

According to the present invention, since the terminal receiver can be elastically deformed or expanded by the elastic member in response to the shape of the terminal inserted therein, a variety of terminals having different diameters can be easily coupled to the terminal receiver.

Although exemplary embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A battery module comprising:
a plurality of unit batteries, each comprising an electrode terminal; and
a connecting member for interconnecting at least two electrode terminals,
wherein the connecting member comprises a coupling device configured to receive and elastically grip the electrode terminal.

2. The battery module of claim 1, wherein the connecting member further comprises another coupling device, wherein the coupling devices are electrically connected to each other by a conductive line.

3. The battery module of claim 1, wherein the coupling device comprises a terminal receiver to receive the electrode terminal and an elastic member biasing the terminal receiver toward the electrode terminal so that the terminal receiver firmly grips the electrode terminal.

4. The battery module of claim 3, wherein the terminal receiver comprises an elastically movable piece comprising a surface configured to contact the electrode terminal, and wherein the surface is complementary to an exterior contour of the electrode terminal.

5. The battery module of claim 4, wherein the elastically movable piece is formed of a metal.

6. The battery module of claim 4, wherein the surface comprises a curved portion.

7. The battery module of claim 4, wherein the surface comprises a threaded portion.

8. The battery module of claim 3, wherein the coupling device further comprises a housing enclosing the terminal receiver and the elastic member.

9. The battery module of claim 3, wherein the elastic member comprises a spring.

10. The battery module of claim 3, wherein the elastic member is selected from the group consisting of a tension spring, a compression spring and an elastic band.

11. The battery module of claim 1, wherein the coupling device comprises an elastically movable piece configured to receive and grip differently sized electrode terminals.

12. The battery module of claim 1, wherein the coupling device comprises a movable piece and an elastic member connected to the movable piece, and wherein the elastic member is to cause the movable piece to elastically move so as to contact the electrode terminal.

13. The battery module of claim 12, wherein the movable piece is configured to substantially sheathe the electrode terminal.

14. The battery module of claim 12, wherein the movable piece is substantially cylindrically configured with a hollow so as to receive and seize the electrode terminal within the hollow.

15. The battery module of claim 14, wherein the cylindrically configured movable piece is made of a single curled sheet with two edges, which are connected by the elastic member.

16. The battery module of claim 12, wherein the coupling device comprises two or more movable pieces connected to each other via two or more elastic members so as to form a cylindrical configuration with a hollow to receive the electrode terminal therein.

17. The battery module of claim 12, wherein the coupling device further comprises a case housing the movable piece and the elastic member, wherein the movable piece is arranged to form a space to receive the electrode terminal therein with or without one or more other movable pieces, and wherein the elastic member is located between the movable piece and the case, and is configured to cause the movable piece to elastically move within the case.

18. The battery module of claim 12, wherein the coupling device further comprises a guide member configured to guide receiving of the electrode terminal.

19. The battery module of claim 18, wherein the coupling device further comprises a housing to house the movable piece and the elastic member, and wherein the guide member connects one end of the housing to one end of the movable piece.

20. The battery module of claim 18, wherein the guide member is formed of an elastic material.

21. The battery module of claim 18, wherein the guide member is formed in a band shape.
